(19) United States
(12) Patent Application Publication
(10) Pub. No.: US 2011/0320382 A1
(43) Pub. Date: Dec. 29, 2011

(54) BUSINESS PROCESS ANALYSIS METHOD, SYSTEM, AND PROGRAM

(75) Inventors: Michiharu Kudo, Kanagawa-ken (JP); Naoto Sato, Kanagawa-ken (JP)

(73) Assignee: INTERNATIONAL BUSINESS MACHINES CORPORATION, Armonk, NY (US)

(21) Appl. No.: 13/160,733

(22) Filed: Jun. 15, 2011

(30) Foreign Application Priority Data
Jun. 29, 2010 (JP) 2010-148316

(51) Int. Cl. G06Q 10/00

(52) U.S. Cl. 705/348

(57) ABSTRACT

A business process analysis method, system, and program. The technique includes processing to simplify a log, processing to refine a regular grammar on the basis of the simplified log, and processing to generate a workflow on the basis of the resultant refined regular grammar, each processing being performed through computer processing. The processing includes steps of creating a work graph on the basis of a work log, using the work graph to simplify the work log by deleting redundancies, reading a set of constraints, providing a regular expression, changing the regular expression by applying the set of constraints to it, applying the changed regular expression to the simplified log, and determining if the changed regular expression is appropriate for the simplified log.

### CROSS REFERENCE TO RELATED APPLICATION

This application claims priority under 35 U.S.C. 119 from Japanese Application 2010-148316, filed Jun. 29, 2010, the entire contents of which are incorporated herein by reference.

### BACKGROUND OF THE INVENTION

1. Field of the Invention

The present invention relates to a business process analysis method, system, and program for extracting business processes by analyzing work logs recorded in a computer-readable medium.

2. Description of Related Art

In recent years, inevitable globalization of business and wide spread adoption of cloud computing services make it more and more difficult for interested parties to figure out their business process procedures. In the meanwhile, business process management (BPM) has been drawing increasing attention from corporate executive officers. For example, one of top priorities for corporate chief information officers is to improve their business processes.

Conventional commercial tools for BPM solutions mainly function to support a structured business process, i.e., a workflow based on routine and specific rules. Such tools are suitable for the automation of workflows given set formats, such as expense management and purchase process. The BPM technologies enable visualization of an actual operation situation by analyzing event logs generated by such a routine workflow.

There are, however, many application fields where it is difficult to build routine workflow models of their business processes. That is, business processes are hardly or not at all structured; rather, they are extremely dynamic, highly dependent on workers, and have an ad-hoc aspect.

The concept of case management or adaptive workflow represents a solution for an agile process that allows the user to dynamically change a process and create a new process in a desired form. For example, various risk evaluations in businesses, medical underwritings, and insurance assessments are some typical business processes in the real world that require dynamic and human-oriented determination by persons with various types of roles, such as a risk manager, an on-site assessor, an examiner, a doctor, a lawyer, and an assessor.

One of the major problems related to a process that is hardly or not at all structured is that it is difficult to visualize what is actually happening, e.g., who is performing which task in which order. If such a process is managed by a centralized operation engine, the visualization is not very difficult. In reality, however, people tend to cooperate with one another by using email, chat, and individual business tools, which makes it more difficult to visualize what is actually happening in business processes.

A conventional process mining technique such as the α-algorithm is effective for visualizing a business process which has been structured based on given event logs, but is not so effective for an unstructured business process. That is, applying the process mining to an unstructured business process only provides a complicated and disorganized result, which is far from what the analyst expects.

In view of such circumstances, a process mining technique called Heuristic Miner has been recently proposed by A. J. M. M. Weijin, W. M. P. van der Aalst and A. K. Alves de Medeirons, (Process mining with the heuristicsminer algorithm, Research School for Operations Management and Logistics, 2006).

In addition, a technique called Fuzzy Mining has been recently proposed by Christian W. Gunther and Wil M. P. van der Aalst (Fuzzy mining—adaptive process simplification based on multi-perspective metrics, In proceedings of the 5th International Conference on Business Process Management, 2007), and Wil M. P. van der Aalst and Christian W. Gunther (Finding structure in unstructured processed: The case for process mining, In Proceedings of the 7th International Conference on Application of Concurrency to System Design, 2007).

Algorithms provided by these techniques use measures, such as dependence probability, importance, and correlation, to collect nodes and disconnect links to provide a structure to an unstructured process. While these algorithms can efficiently handle exceptions and noises included in logs, only limited effects can be achieved in actual applications of certain types.

The following patent literatures will now be described as they relate to the present invention:

Japanese Patent Application Publication No. 2003-108574 discloses the following purchase rule model construction system: Specifically, from a database in which purchase records are recorded, the purchase records of customers are transformed into symbol strings by using another database containing a symbol list in which purchased goods are associated with specific symbols. The symbol strings obtained by the transformation are then substituted with the same or a fewer number of symbols so as to index the symbol strings. On the other hand, multiple regular expression candidates are generated by appropriately combining some of the symbols used in the symbol strings. Then, the indexed symbol strings are evaluated as to which candidates among the multiple regular expression candidates are included in the indexed symbol strings so that a useful purchase rule and pattern that exist in the purchase records may be found. In this way, an accurate purchase rule model can be constructed without relying on experts' abilities.

Japanese Patent Application Publication No. 2006-236262 discloses a system that allows general users to take out and utilize text contents holding useful information without analyzing tags or creating extraction rules. Specifically, the system includes: a recording unit that records a pattern format having a regular expression; an extraction rule generating unit that generates an extraction rule for taking out, from a HTML page, a text content that matches the pattern format; and a format transforming unit that performs transformation into a predetermined format on the basis of the extraction rule.

Nonetheless, neither of these patent literatures discloses a technique for extracting a meaningful rule from a log of an unstructured business process.

### BRIEF SUMMARY OF THE INVENTION

To overcome these deficiencies, the present invention provides a method of creating a workflow including: creating a work graph on the basis of a work log, wherein the work log is recorded through a series of operations performed by an operator; identifying and removing a redundant graph in the created work graph; simplifying the work log by deleting an entry corresponding to the removed redundant graph from the work log; reading a set of constraints to be satisfied by log entries, wherein each of the constraints defines an expression including a regular expression having a variable; changing a prepared regular expression by applying one of the constraints to an initial value of the prepared regular expression; determining whether the changed regular expression is appropriate for the simplified log; and creating a graph of a workflow by creating a finite state transition system on the basis of the changed regular expression in response to a determination that the changed regular expression is appropriate.

According to another aspect, the present invention provides an article of manufacture tangibly embodying computer readable instructions which, when executed, cause a computer to carry out the steps of a method for creating a workflow, the method including: a computer readable storage medium having computer readable program code embodied therewith, the computer readable program code configured to perform the steps of: creating a work graph on the basis of a work log, wherein the work log is recorded through a series of operations performed by an operator; identifying and removing a redundant graph in the created work graph; simplifying the work log by deleting an entry corresponding to the removed redundant graph from the work log; reading a set of constraints to be satisfied by log entries, wherein each of the constraints defines an expression including a regular expression having a variable; changing a prepared regular expression by applying one of the constraints to an initial value of the prepared regular expression; determining whether the changed regular expression is appropriate for the simplified log; and creating a graph of a workflow by creating a finite state transition system on the basis of the changed regular expression in response to a determination that the changed regular expression is appropriate.

According to yet another aspect, the present invention provides a system for creating a workflow including: means for creating a work graph on the basis of a work log, wherein the work log is recorded through a series of operations performed by an operator; means for identifying and removing a redundant graph in the created work graph; means for simplifying the work log by deleting an entry corresponding to the removed redundant graph from the work log; means for reading a set of constraints to be satisfied by log entries, wherein each of the constraints defines an expression including a regular expression having a variable; means for changing a prepared regular expression by applying one of the constraints to an initial value of the prepared regular expression; means for determining whether the changed regular expression is appropriate for the simplified log; and means for creating a graph of a workflow by creating a finite state transition system on the basis of the changed regular expression in response to a determination that the changed regular expression is appropriate.

### BRIEF DESCRIPTION OF THE SEVERAL VIEWS OF THE DRAWINGS

FIG. 1 is a block diagram showing an example of a hardware configuration for carrying out the present invention.

FIG. 2 is a functional block diagram according to an embodiment of the present invention.

FIG. 3 is a diagram showing an example of an operation log.

FIG. 4 is a diagram showing a flowchart of the whole process according to an embodiment of the present invention.

FIG. 5 is a diagram showing an example of log simplification.

FIGS. 6A and 6B are diagrams showing N-N node type graphs.

FIG. 7 is a diagram showing a flowchart of processing for N-N node type detection for the log simplification.

FIG. 8 is a diagram showing a graph of a subroutine type graph.

FIG. 9 is a diagram showing a graph of a switch type graph.

FIG. 10 is a diagram showing a graph of a merge type graph.

FIG. 11 is a diagram showing a graph of a branch type graph.

FIG. 12 is a diagram showing a flowchart of processing for getMerge.

FIG. 13 is a diagram showing a flowchart of processing for getBranch.

FIG. 14 is a diagram showing a flowchart of processing for getDistance.

FIG. 15 is a diagram showing a flowchart of processing for subroutine type detection.

FIG. 16 is a diagram showing a flowchart of processing for switch type detection.

FIGS. 17A to 17C are diagrams showing typical patterns for removing a node.

FIG. 18 is a diagram showing a flowchart of processing for score calculation.

FIG. 19 is a diagram showing an example of transition of the simplification processing on the operation log.

FIG. 20 is a diagram showing the number of nodes, the number of links, and scores at each transition of the simplification processing on the operation log.

FIG. 21 is a diagram showing a flowchart showing an overview of log refinement processing.

FIG. 22 is a diagram showing a flowchart of processing by a refinement submodule.

FIG. 23 is a diagram showing a flowchart of processing by an examination submodule.

FIG. 24 is a diagram showing a flowchart of processing by a transformation submodule.

FIG. 25 is a diagram showing a flowchart of processing by substitution submodule.

FIG. 26 is a diagram showing a flowchart of processing of transforming a ε-NFA to a DFA.

FIG. 27 is a diagram showing a flowchart of processing of generating a pseudo-workflow from the DFA.

FIG. 28 is a diagram showing a flowchart of processing of generating a workflow from the pseudo-workflow.

FIG. 29 is a diagram showing an example of a state transition system generated based on a regular expression.

FIG. 30 is a diagram showing an example of a workflow generated based on the state transition system.

### DETAILED DESCRIPTION OF THE PREFERRED EMBODIMENTS

Hereinbelow, an embodiment of the present invention will be described by referring to the drawings. Reference numerals that are the same across the drawings represent the same components unless otherwise noted. It is to be understood that what is described below is just one mode for carrying out the present invention and is not intended to limit the present invention to the contents described in the embodiment.

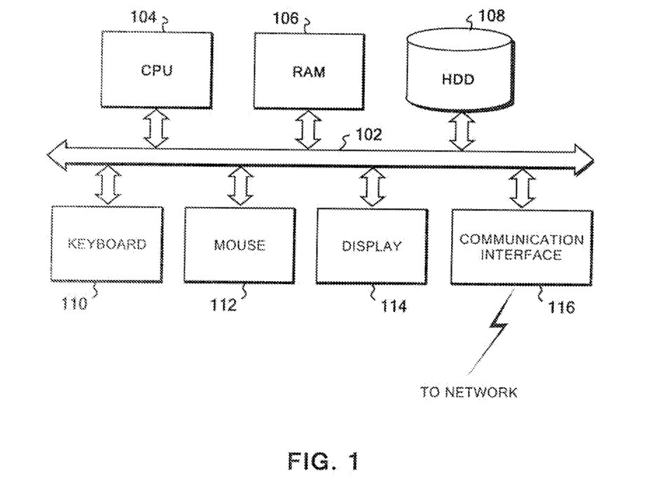

Referring to FIG. 1, there is shown a block diagram of computer hardware for achieving a system configuration and processing according to an embodiment of the present invention. In FIG. 1, a CPU 104, a main memory (RAM) 106, a hard disk drive (HDD) 108, a keyboard 110, a mouse 112, and a display 114 are connected to a system bus 102. The CPU 104 is preferably one based on a 32-bit or 64-bit architecture. For example, Pentium® 4, Core™2 Duo, or Xeon® of Intel® Corporation, Athlon™ of AMD or the like can be used for the CPU 104. The main memory 106 is preferably one having a capacity of 2 GB or larger. The hard disk drive 108 is preferably one having a capacity of 320 GB or larger, for example.

The hard disk drive 108 stores, in advance, an operating system therein, though it is not illustrated here. This operating system may be any operating system that is compatible with the CPU 104, such as Linux®, Windows® 7, Windows® XP, or Windows® 2000 of Microsoft Corporation, or Mac OS® of Apple Inc.

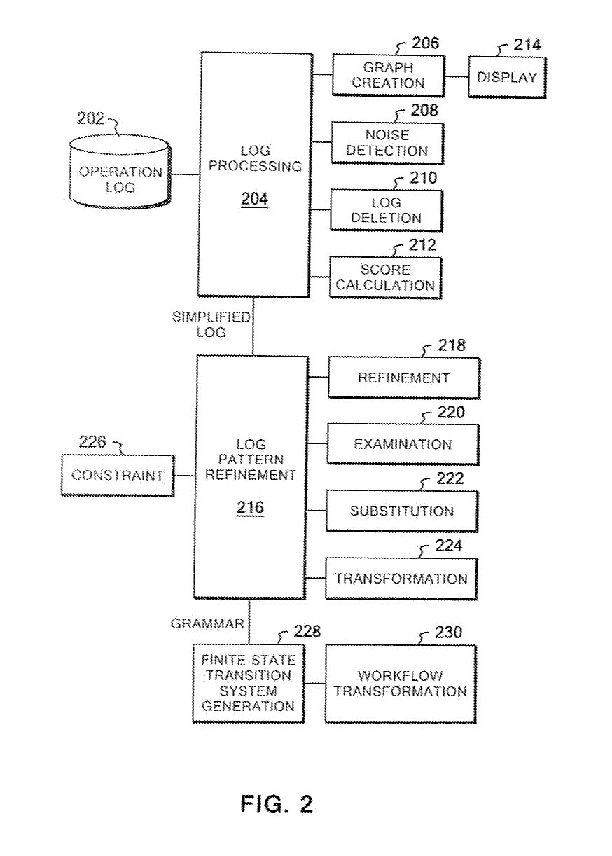

The hard disk drive 108 further stores the following to be described later in detail: an operation log file; a group of log processing modules aimed to simplify a log; a group of log pattern refinement modules for acquiring an appropriate regular grammar on the basis of the simplified log; a module for transforming the acquired regular grammar into a finite transition system; a module for generating a workflow from the finite transition system; and the like. These modules can be created with a programming language processing system of any known programming language, such as C, C++, C#, or Java®. With the help of the operating system, these modules are loaded into the main memory 106 and executed as appropriate. Operations of the modules will be described later in more detail by referring to a functional block diagram in FIG. 2.

The keyboard 110 and the mouse 112 are used for activating the following: the operation log file; the group of log processing modules aimed to simplify a log; the group of log pattern refinement modules for acquiring an appropriate regular grammar on the basis of the simplified log; the module for transforming the acquired regular grammar into a finite transition system; the module for generating a workflow from the finite transition system; and the like. The keyboard 110 and the mouse 112 are also used for typing characters, and the like.

The display 114 is preferably a crystal liquid display. One with any resolution, e.g., XGA (resolution: 1024×768) or UXGA (resolution: 1600×1200), may be used. The display 114 is used to display a graph generated from an operation log.

Further, the system in FIG. 1 is connected to an external network, such as a LAN or a WAN, through a communication interface 116 connected to the bus 102. By using a technology such as ethernet, the communication interface 116 exchanges data with a system such as a server located on the external network.

The server (not illustrated) is connected to a client system (not illustrated) manipulated by an operator of a given work. When the operator manipulates the client system, an operation log file stored in the server is collected through the network into the system in FIG. 1 for the purpose of an analysis.

Next, by referring to FIG. 2, a description will be given of the roles of the file and the functional modules stored in the hard disk drive 108 in accordance with the present invention.

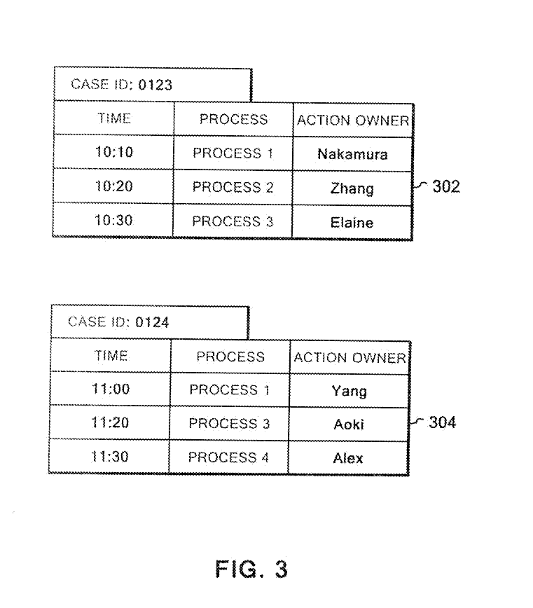

In FIG. 2, an operation log 202 is a file in which the results of manipulations performed by operators of given works are recorded. As shown in FIG. 3, the operation log 202 is formed of multiple log files 302 and 304. The operation log 202 actually includes many more log files, but only two files are shown here for illustrative purposes.

As shown in FIG. 3, each individual log file is given a unique case ID. Each log file has at least fields for the time and process, and, preferably, a field for the action owner. In the time field, a system time at which a process is recorded is preferably inputted; however, knowing at least the chronological order of processes may be enough for achieving the object of the present invention. In the process field, a process ID is stored corresponding to a predefined process such as “start-claim-processing,” “complete-preprocessing,” “start-machine-based-claim-examination”, or “start-checking.”

Referring back to FIG. 2, a log processing module 204 has functions to find a redundant entry in the operation log 202 and to simplify the operation log 202. The log processing module 204 includes a graph creation submodule 206, a noise detection submodule 208, a log deletion submodule 210, a score calculation submodule 212, and a display submodule 214. The graph creation submodule 206 reads the operation log 202 and creates a graph in which the contents of processing serve as nodes and the chronological relationship between the contents of the processing serve as a directed link. This technique utilizes an algorithm described in Wil M. P. van der Aalst, B. F. van Dongen, “Discovering Workflow Performance Models from Timed Logs”, Proceedings of the International Conference on Engineering and Deployment of Cooperative Information Systems, 2002, p9, Definition 3.6, for example.

The noise detection submodule 208 recognizes, as a noise, a node of an exceptional process in the graph created by the graph creation submodule 206.

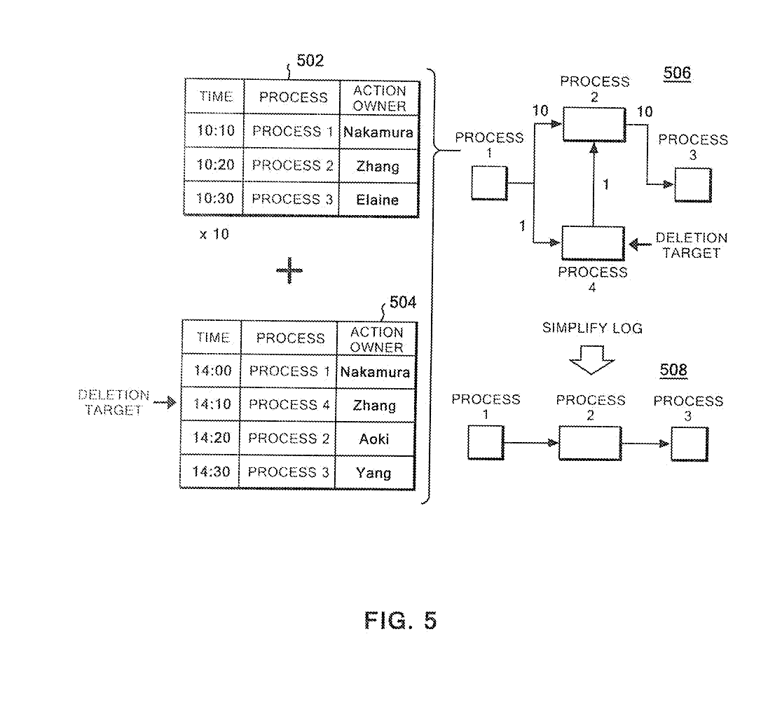

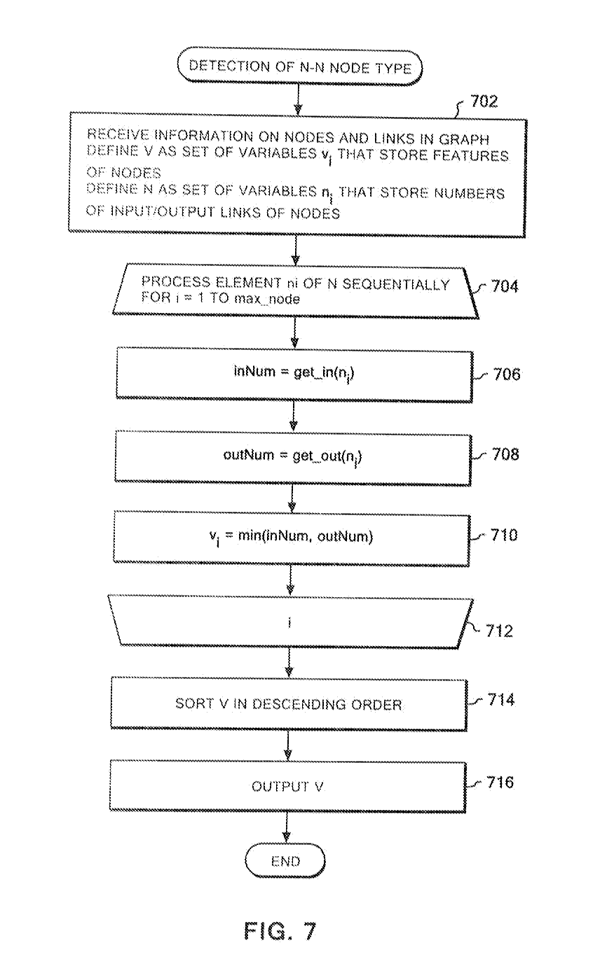

FIG. 5 is a diagram schematically showing the log simplification processing. FIG. 5 is a case where the graph creation submodule 206 has formed a graph 506 from log files 502 and 504. In this case, there are ten log files in the form of the log file 502, and one log file in the form of the log file 504. Then, the noise detection submodule 208 recognizes a node of a process 4 as a deletion target. Accordingly, an entry of the process 4 in the log file 504 is recognized as a deletion target. The processing by the noise detection submodule 208 will be described later in more detail by referring to a flowchart in FIG. 7 and the like.

The log deletion submodule 210 deletes an entry of a log that corresponds to a node recognized as a noise by the noise detection submodule 208. To show this in the example in FIG. 5, the log deletion submodule 210 deletes the entry of the process 4 in the log file 504, which has been recognized as a deletion target by the noise detection submodule 208. As a result, a graph is re-created by the graph creation submodule 206 as graph 508.

The score calculation submodule 212 has a function to apply various variations to the graph re-created by the graph creation submodule 206 from the operation log with a noise deleted therefrom, and to calculate a score for each variation. The processing by the score calculation submodule 212 will be described later in more detail.

The display submodule 214 has a function to display, on the display 114, the graph created by the graph creation submodule 206 or the graph with the variation applied thereto by the score calculation submodule 212.

The log processing module 204 transfers a simplified log, which is the result of the above processing, to a log pattern refinement module 216.

The log pattern refinement module 216 includes a refinement submodule 218, an examination submodule 220, a substitution submodule 222, and a transformation submodule 224. The log pattern refinement module 216 has a function to output a regular grammar based on the received simplified log by using data containing constraints 226 that are defined by the user and stored in the hard disk drive 108 or the main memory 106. The processing by the log pattern refinement module 216 will be described later in more detail.

A finite state transition system generation module 228 has a function to receive the regular grammar outputted from the log pattern refinement module 216 and to transform the regular grammar into a finite state transition system.

A workflow transformation module 230 has a function to generate a workflow from data of the finite state transition system received from the finite state transition system generation module 228.

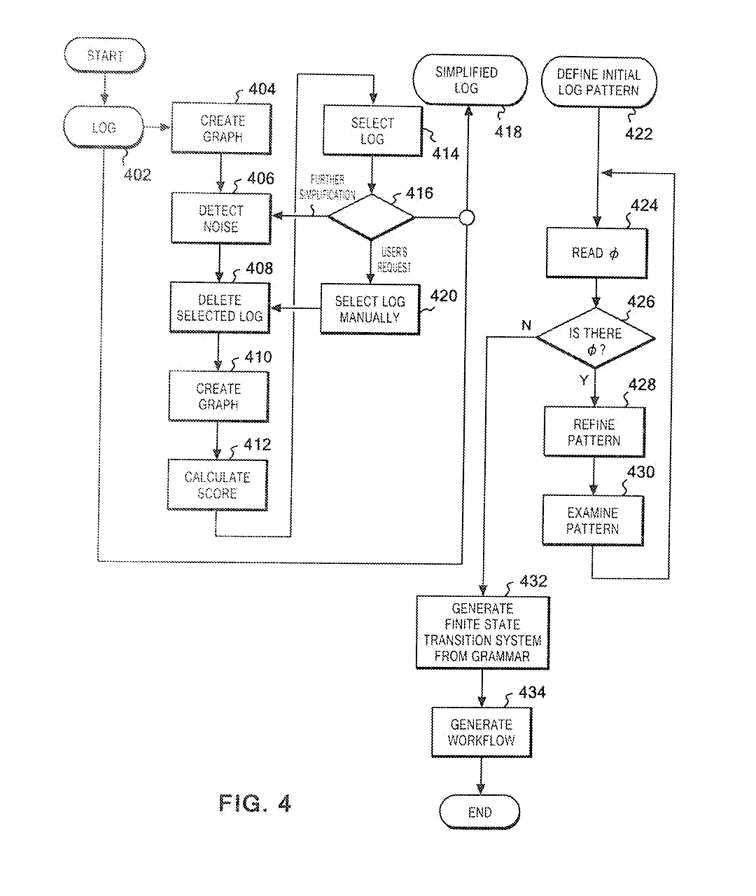

Next, an overview of the processing according to the present invention will be described by referring to a flowchart in FIG. 4. In FIG. 4, a log 402 is equivalent to one depicted as the operation log 202 in FIG. 2.

In step 404, the graph creation submodule 206 reads the log 402 and creates a graph.

In step 406, the noise detection submodule 208 performs noise detection on the basis of the graph created by the graph creation submodule 206.

In step 408, the log deletion submodule 210 deletes an entry of a log recognized as a noise by the noise detection submodule 208.

In step 410, the graph creation submodule 206 reads the log 402 with the entry deleted therefrom and creates a new graph.

In step 412, the score calculation submodule 212 performs score calculation and displays scores of different variations for the graph. In step 414, the log processing module 204 displays the variations and the scores thereof, which are calculated by the score calculation submodule 212, on the display 114 and allows the user to select one of the variations.

If the user's determination in step 416 is such that the user accepts and selects one of the variations, a log 418 simplified in accordance with the result of such selection is sent to a log refinement step that follows. If the user's determination in step 416 is such that further simplification is determined to be necessary, the processing returns to the noise detection in step 406.

If the user's determination in step 416 is such that the user desires to manually select a log to be deleted, then in step 420, the log processing module 204 displays the graph on the display 114 and allows the user to select a node to be deleted in the graph through operations of the mouse 112 or the like. After that, in step 408, an entry of a log corresponding to the selected node in the graph is deleted, followed by the processing in and after step 410.

When the simplified log 418 is finally established, then in step 422, the log pattern refinement module 216 provides an initial log pattern which is defined by the user or scheduled in advance by the system.

In step 424, the log pattern refinement module 216 reads φ being one of the constraints 226 defined by the user.

In step 426, the log pattern refinement module 216 determines whether there is any unprocessed constraint φ. If there is, the log pattern refinement module 216 calls the refinement submodule 218 in step 428 to refine the log pattern. The log pattern refinement module 216 then calls the examination submodule 220 in step 430 to determine whether traces, which are a sequence of processes acquired from the simplified log 418, are valid. If it is determined that traces are valid, the log pattern refinement module 216 accepts the resultant log pattern. If not, the log pattern refinement module 216 rejects the resultant pattern.

The processing returns to step 426. If it is determined in step 426 that there is no unprocessed constraint φ, the processing proceeds to step 432 with the resultant log pattern as an output regular grammar. There, the finite state transition system generation module 226 transforms the regular grammar into a finite state transition system. Next, in step 434, the workflow transformation module 230 transforms the finite state transition system thus acquired into a workflow.

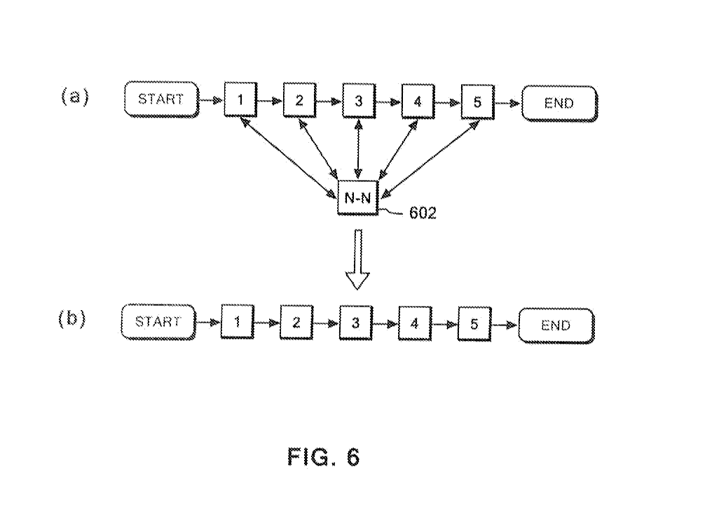

Next, the function of the noise detection submodule 208 in FIG. 2 will be described in more detail by referring to FIGS. 6 to 17. The noise detection submodule 208 detects a certain node or process by detecting various characteristics in a created graph. The log deletion submodule 210 then deletes the detected node.

A pattern shown in FIG. 6 is called in this embodiment an N-N node type representing a case where links are established between a single node and multiple other nodes. In an example in FIG. 6A, a node 602 is detected as a node to be removed. As a result, obtained is a flat graph as shown in FIG. 6B, from which the node 602 has been removed.

Processing to detect a graph of the N-N node type as above will be described by referring to a flowchart in FIG. 7. In step 702, the noise detection submodule 208 receives a graph node and link information. To be specific, V is defined as a set of variables vᵢ that store the features of nodes. Moreover, N is defined as a set of variables iₙ that store the numbers of input/output links of nodes. The sets V and N can be implemented in the form of an array of structures, or the like.

A series of steps from step 704 to step 712 is performed sequentially on the elements i of N for i=1 to max_node. Here, max_node refers to the number of nodes to be processed.

In step 706, a function get_in(i) is called, and the number of input links of the node i is assigned to inNum variable.

In step 708, a function get_out(i) is called, and the number of output links of the node i is assigned to outNum variable.

In step 710, in accordance with vᵢ=min(inNum,outNum), a value of either inNum or outNum, whichever is smaller, is assigned to vᵢ.

By the time of the exit from the loop in step 712, the values of the variables vᵢ are prepared for i=1 to max_num. Then, in step 714, the noise detection submodule 208 sorts V in a descending order. Thereafter, in step 716, the noise detection submodule 208 outputs V. Of the nodes with values obtained by min(inNum,outNum), a node with the greatest value appears at the top in V.

The node at the top in V is recognized as a node to be deleted, and the log deletion submodule 210 actually deletes the corresponding entry from the operation log 202.

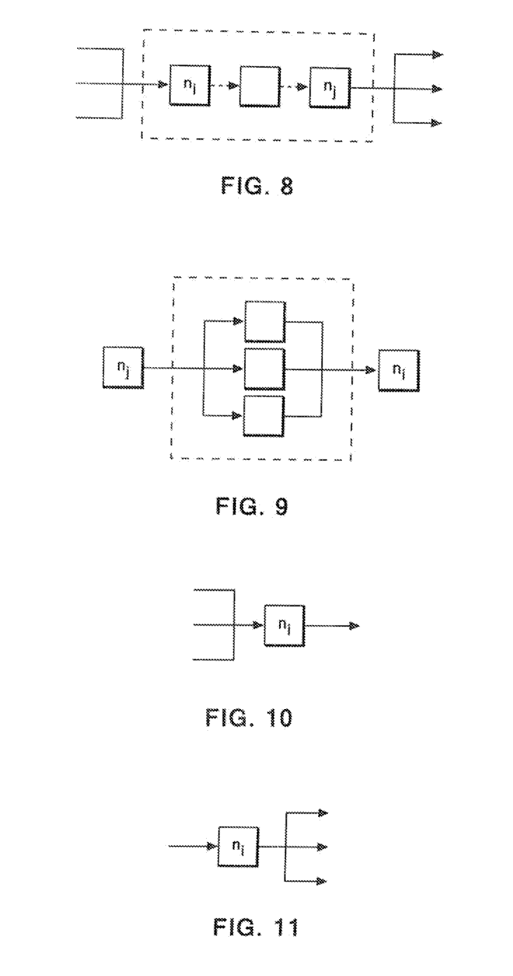

Some other types of graphs which the noise detection submodule 208 recognizes as a deletion target include a subroutine type shown in FIG. 8 and a switch type shown in FIG. 9.

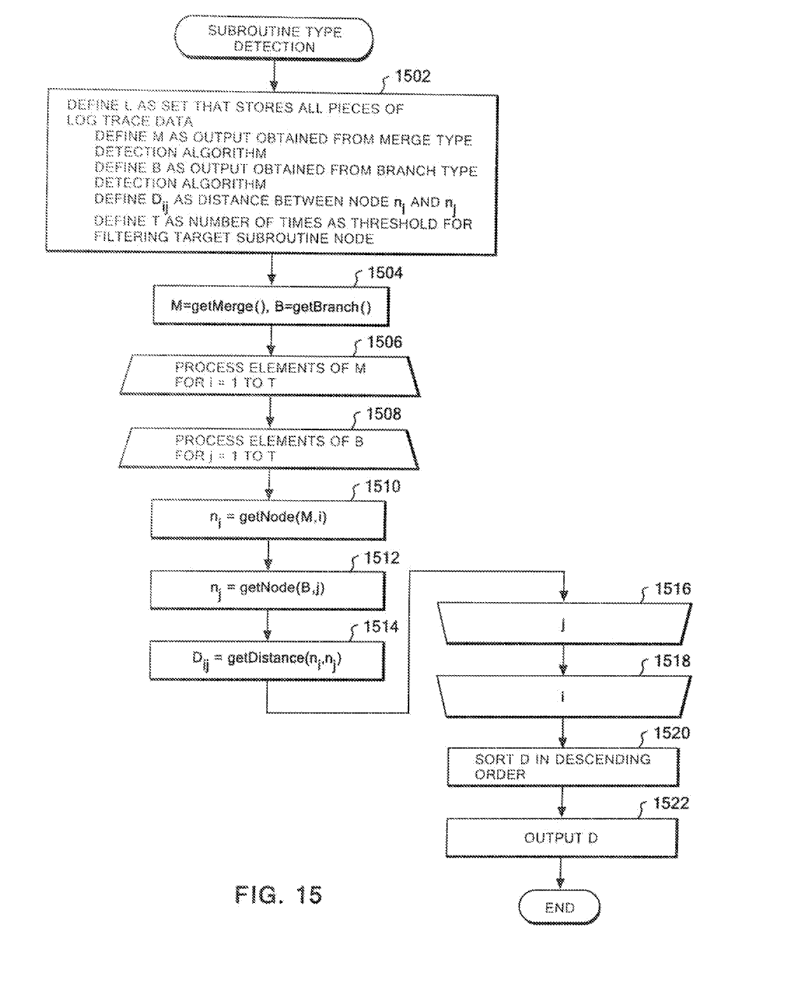

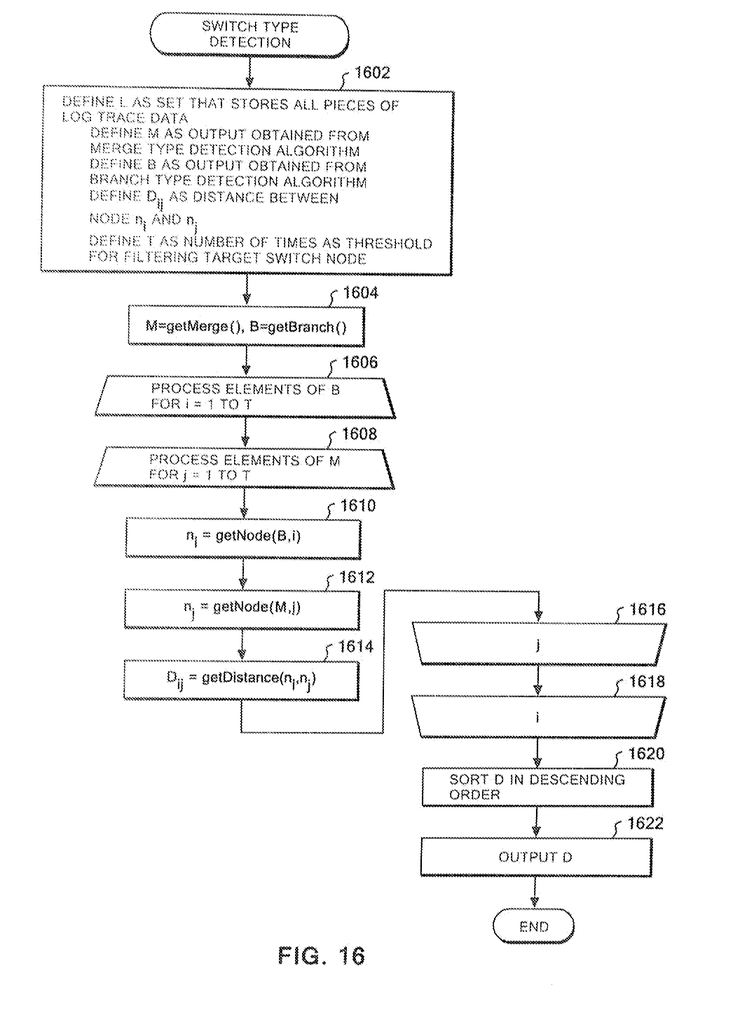

Processing to detect these types of graphs will be described by referring to flowcharts in FIGS. 15 and 16, but before that, a description will be given of getMerge( ) getBranch( ) and getDistance( ) which are functions or subroutines called in the flowcharts in FIGS. 15 and 16.

getMerge( ) detects a pattern in which the number of links outputted from a node is smaller than the number of links inputted to the node as shown in FIG. 10.

getBranch( ) detects a pattern in which the number of links outputted from a node is larger than the number of links inputted to the node as shown in FIG. 11.

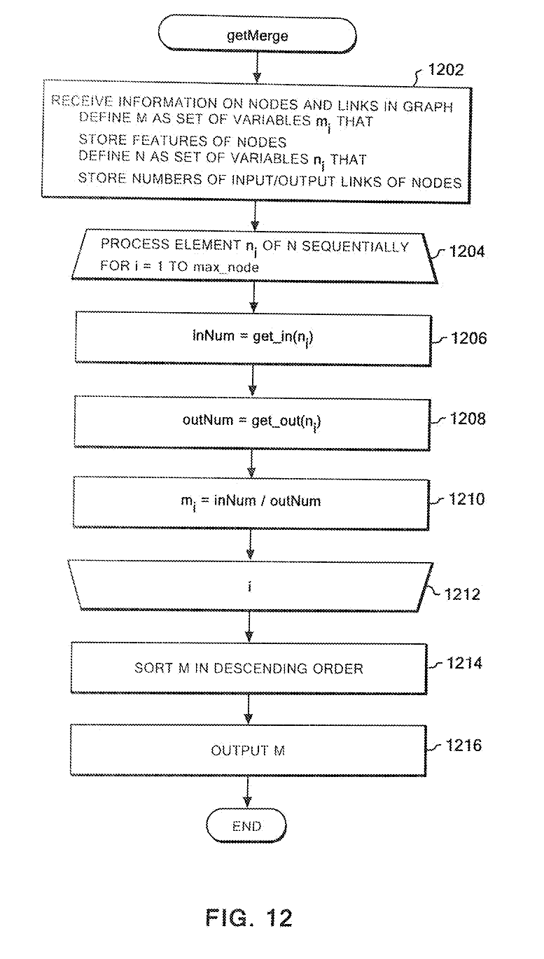

FIG. 12 is a flowchart showing processing of getMerge( ) In step 1202, the noise detection submodule 208 receives a graph and link information. To be specific, M is defined as a set of variables m that store the features of nodes. Moreover, N is defined as a set of variables iₙ that store the numbers of input/output links of nodes. The sets M and N can be implemented in the form of an array of structures, or the like.

A series of steps from step 1204 to step 1212 is performed sequentially on the elements i of N for i=1 to max_node. Here, max_node refers to the number of nodes to be processed.

In step 1206, the function get_in(i) is called, and the number of input links of the node i is assigned to inNum variable.

In step 1208, the function get_out(i) is called, and the number of output links of the node i is assigned to outNum variable.

In step 1210, in accordance with mᵢ=inNum/outNum, a value obtained by dividing inNum by outNum is assigned to mᵢ.

By the time of the exit from the loop in step 1212, the values of the variables mᵢ are prepared for i=1 to max_num. Then, in step 1214, the noise detection submodule 208 sorts M in the descending order. Thereafter, in step 1216, the noise detection submodule 208 outputs M. Of the nodes with values obtained by min(inNum,outNum), a node with the greatest value appears at the top in M.

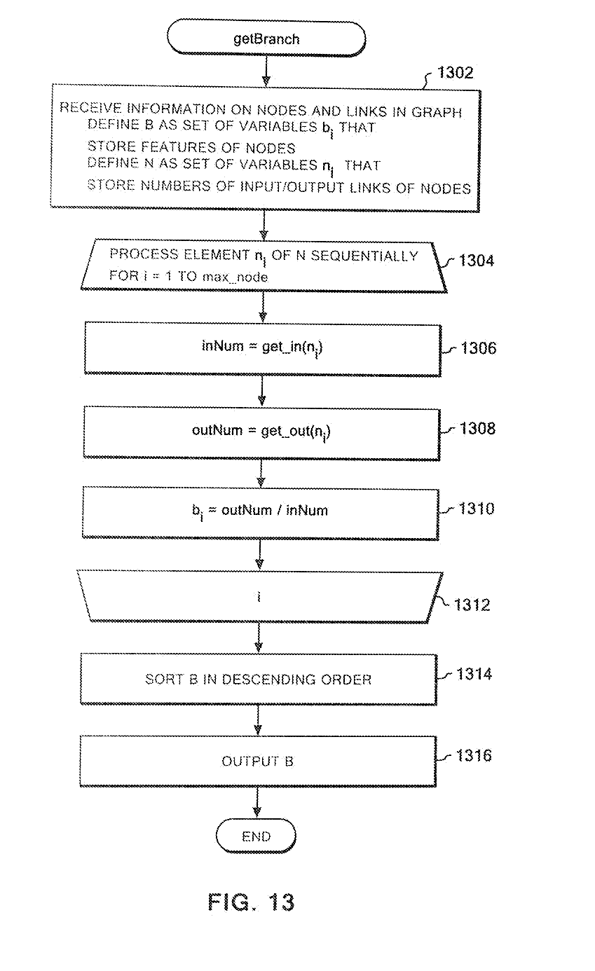

FIG. 13 is a flowchart showing processing of getBranch( ) In step 1302, the noise detection submodule 208 receives a graph node and link information. To be specific, B is defined as a set of variables bᵢ that store the features of nodes, respectively. Moreover, N is defined as a set of variables iₙ that store the numbers of input/output links of nodes, respectively. The sets B and N can be implemented in the form of an array of structures, or the like.

A series of steps from step 1304 to step 1312 is performed sequentially on the elements i of N for i=1 to max_node. Here, max_node refers to the number of nodes to be processed.

In step 1306, the function get_in(i) is called, and the number of input links of the node i is assigned to inNum variable.

In step 1308, the function get_out(i) is called, and the number of output links of the node iₙ is assigned to outNum variable.

In step 1310, in accordance with bᵢ=inNum/outNum, a value obtained by dividing inNum by outNum is assigned to bᵢ.

By the time of the exit from the loop in step 1312, the values of the variables b, are prepared for i=1 to max_num. Then, in step 1314, the noise detection submodule 208 sorts B in the descending order. Thereafter, in step 1316, the noise detection submodule 208 outputs B. Of the nodes with values obtained by min(inNum,outNum), a node with the greatest value appears at the top in B.

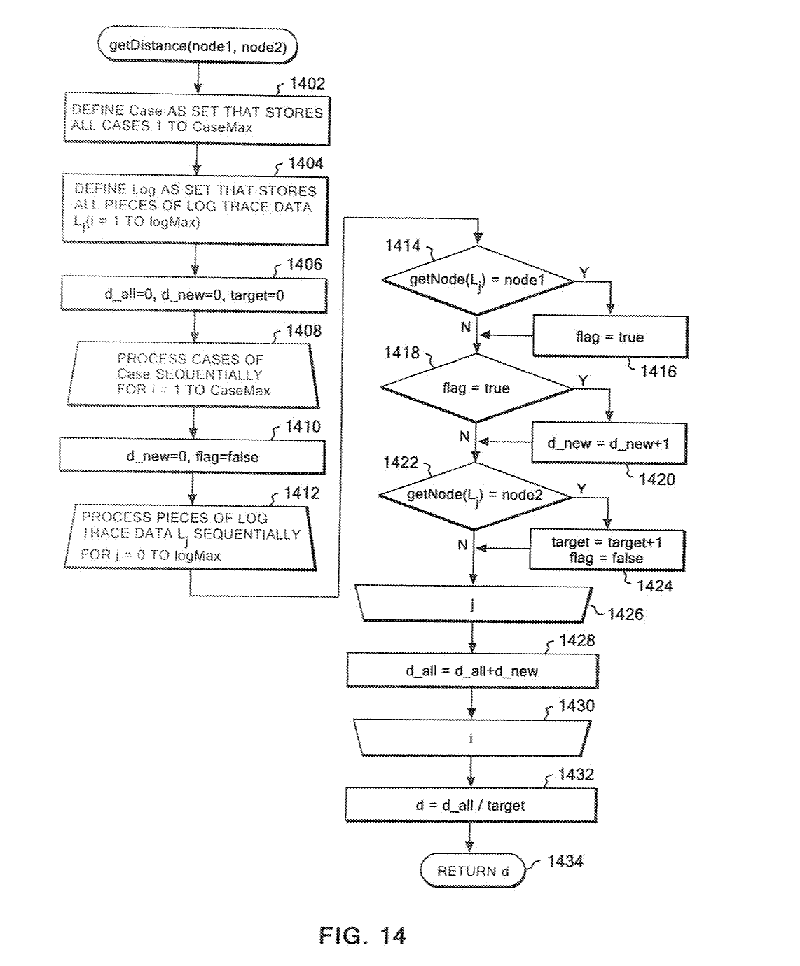

Next, processing for getDistance(node1,node2) will be described by referring to FIG. 14. In step 1402, Case is defined as a set that stores all cases 1 to caseMax. In step 1404, Log is defined as a set that stores all pieces of log trace data Lᵢ (i=1 to logMax).

In step 1406, variables are set such that d_all=0, d_new=0, and target=0.

A series of steps from step 1408 to step 1430 is performed sequentially on cases of Case for i=1 to caseMax.

In step 1410, setting is performed such that d_new=0 and flag=false.

Next, a series of steps from step 1412 to step 1426 is performed sequentially for a variable j from j=1 to logMax on the pieces of log trace data Lⱼ of Log.

In step 1414, it is determined whether getNode(Lⱼ)=node1, i.e., whether Lⱼ includes the node given as the first argument in getDistance( ).

If so, flag=true is set in step 1416.

In step 1418, it is determined whether or not flag=true. If so, d_new is incremented in accordance with d_new=d_new+1 in step 1420.

In step 1422, it is determined whether getNode(Lⱼ)=node2, i.e., whether Lⱼ includes the node given as the second argument in getDistance( ). If so, target is incremented in accordance with target=target+1 and flag=false is set in step 1424.

After exiting from the j loop in step 1426, d_new is added to d_all in accordance with d_all=d_all+d_new in step 1428.

After exiting from the i loop in step 1430, d is calculated from d=d_all/target in step 1430, and in step 1434 getDistance(node1,node2) returns the value d thus calculated.

Next, processing to detect a subroutine type graph by use of getMerge( ) getBranch( ), and getDistance( ) will be described by referring to a flowchart in FIG. 15.

In step 1502, values are read for variables in advance. To be specific, L is a set that stores all pieces of log trace data. M is a set of outputs obtained from the merge-type detection algorithm. B is a set of outputs obtained from the branch-type detection algorithm. Dᵢⱼ is a distance between a node nᵢ and a node nⱼ. T is the number of times that serves as a threshold for filtering a target subroutine node.

In step 1504, with M=getMerge( ) and B=getBranch( ), the processing in the flowcharts in FIGS. 12 and 13 are called to acquire the values of M and B.

A series of steps from step 1506 to step 1518 is performed on the elements of M for i=1 to T.

A series of steps from step 1508 to step 1516 is performed on the elements of B from j=1 to T.

In step 1510, with nᵢ=getNode(M,i), the i-th node of M is taken out as nᵢ.

In step 1512, with nⱼ=getNode(B,j), the j-th node of B is taken out as nⱼ.

In step 1514, with Dᵢⱼ=getDistance(nᵢ,nⱼ), a distance from the node nᵢ to the node nⱼ is calculated and assigned to Dᵢⱼ.

After exiting from the j loop in step 1516 and exiting from the i loop in step 1518, D including Dᵢⱼ as its element is sorted in the descending order in step 1520.

In step 1522, D is outputted.

Next, processing to detect a switch type graph by use of getMerge( ), getBranch( ), and getDistance( ) will be described by referring to a flowchart in FIG. 16.

In step 1602, values are read for variables in advance. To be specific, L is a set that stores all pieces of log trace data. M is a set of outputs obtained from the merge-type detection algorithm. B is a set of outputs obtained from the branch-type detection algorithm. Dᵢⱼ is a distance between a node nᵢ and a node nⱼ. T is the number of times that serves as a threshold for filtering a target switch node.

In step 1604, with M=getMerge( ) and B=getBranch( ), the processing in the flowcharts in FIGS. 12 and 13 are called to acquire the values of M and B.

A series of steps from step 1606 to step 1618 is performed on the elements of B for i=1 to T.

A series of steps from step 1608 to step 1616 is performed on the elements of M from j=1 to T.

In step 1610, with nᵢ=getNode(B,i), the i-th node of B is taken out as nᵢ.

In step 1612, with nⱼ=getNode(M,j), the j-th node of M is taken out as nⱼ.

In step 1614, with Dᵢⱼ=getDistance(nᵢ,nⱼ), a distance from the node nᵢ to the node nⱼ is calculated and assigned to Dᵢⱼ.

After exiting from the j loop in step 1616 and exiting from the i loop in step 1618, D including Dᵢⱼ as its element is sorted in descending order in step 1620.

In step 1622, D is outputted.

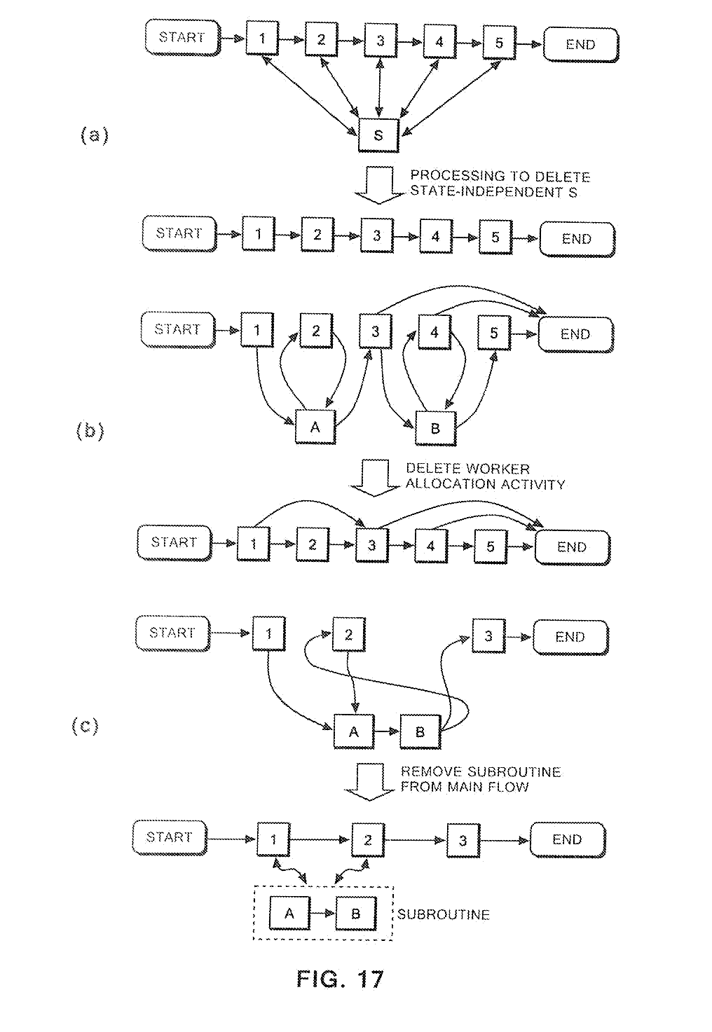

FIGS. 17A to 17C are diagrams showing typical patterns for detecting and removing a node in a graph. FIG. 17A is the same as the N-N type node removal shown in FIGS. 6A and 6B. In this case, a node to be removed is detected by the processing in the flowchart shown in FIG. 7.

FIG. 17B shows a type of processing that removes worker allocation activity nodes. In this case, the processing in the flowchart shown in FIG. 7 is applied twice.

FIG. 17C shows an example of subroutine type node detection. A node to be removed is detected by the processing in the flowchart shown in FIG. 15.

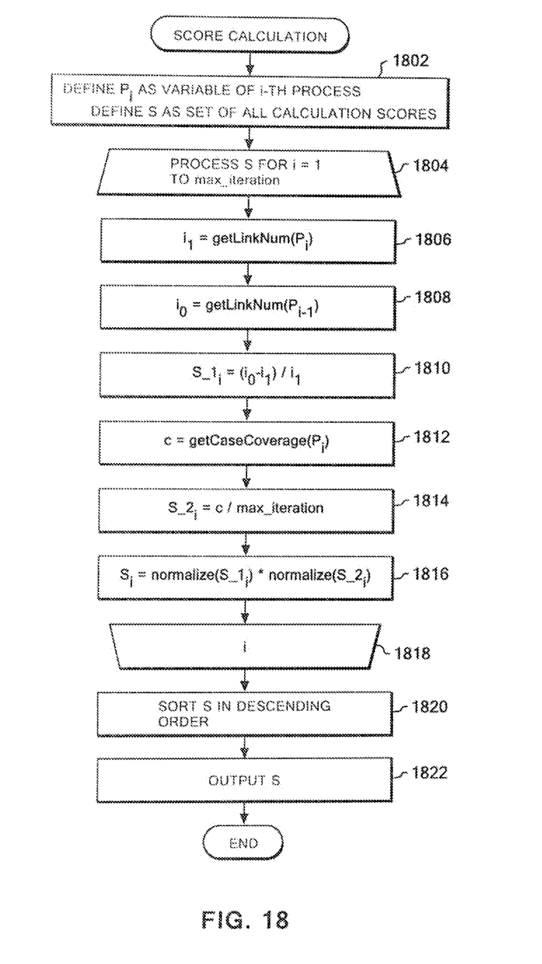

FIG. 18 is a flowchart of processing performed by the score calculation submodule 212 shown in FIG. 2. The processing corresponds to step 412 in the flowchart in FIG. 4.

The processing in the flowchart in FIG. 18 implements an algorithm that calculates a score every time the nodes in a given graph decrease in number as a result of iterating the execution of a series of processing and calling the noise detection submodule 208 and the log deletion submodule 210. The execution here refers to the loop of steps 406, 408, 410, 412, and 414 in FIG. 4. As the user selects further simplification in step 416, the processing proceeds to another execution. In addition, choosing the manual log selection in step 420 brings the processing back to the execution loop from step 408.

Preferably, one of the above-described noise detection algorithms is used such that one loop of the steps would delete only one node in the graph. In this case, the operator may interactively select which one of the noise detection algorithms to use. Alternatively, one of the noise detection algorithms may be selected and used randomly. Still alternatively, by taking into consideration the effects of using the noise detection algorithms, the algorithm that offers the greatest effect may be used. For example, in a case of the N-N node type detection shown in FIG. 7, the log deletion submodule 210 may be used only when the top element in the set V with sorted results has a feature that is above a given threshold.

In a case of, in particular, the subroutine type noise detection shown in FIG. 15, whether a group of subroutine nodes recognized as in the case of FIG. 17C should be deleted or not differs from one case to another. Hence, in the subroutine type noise detection, whether to delete a group of subroutine nodes is desirably determined according to an interactive determination from the operator, rather than relying on the automatic deletion processing of the system.

In step 1802, Pᵢ is defined as a variable representing a pattern obtained as a result of the i-th execution. Moreover, S is defined as a set of all calculation scores.

A series of steps from step 1804 to step 1816 is iterated for S for i=1 to max_iteration.

In step 1806, i₁=getLinkNum(Pᵢ) is calculated. getLinkNum(Pᵢ) is a function that returns the number of links of Pᵢ.

In step 1808, i₀=getLinkNum(Pᵢ₋₁) is calculated.

In step 1810, s_1ᵢ=(i₀−i₁)/i₁ is calculated.

In step 1812, c=getCaseCoverage(Pᵢ) is calculated. Here, getCaseCoverage(Pᵢ) is a function that returns the number of cases in Case which the nodes remaining in Pᵢ can cover.

In step 1814, s_2ᵢ=c/max_iteration is calculated, and in step 1816, sᵢ=normalize(s_1ᵢ)*normalize(s_2ᵢ) is calculated. Here, normalize(s_1ᵢ) is a value obtained by summing s_1ⱼ (j=1 to max_iteration) and dividing s_1ᵢ by the sum. normalize(s_2ᵢ) is calculated similarly.

After exiting from the i loop in step 1818, S is sorted in the descending order in step 1820. In step 1822, S is outputted.

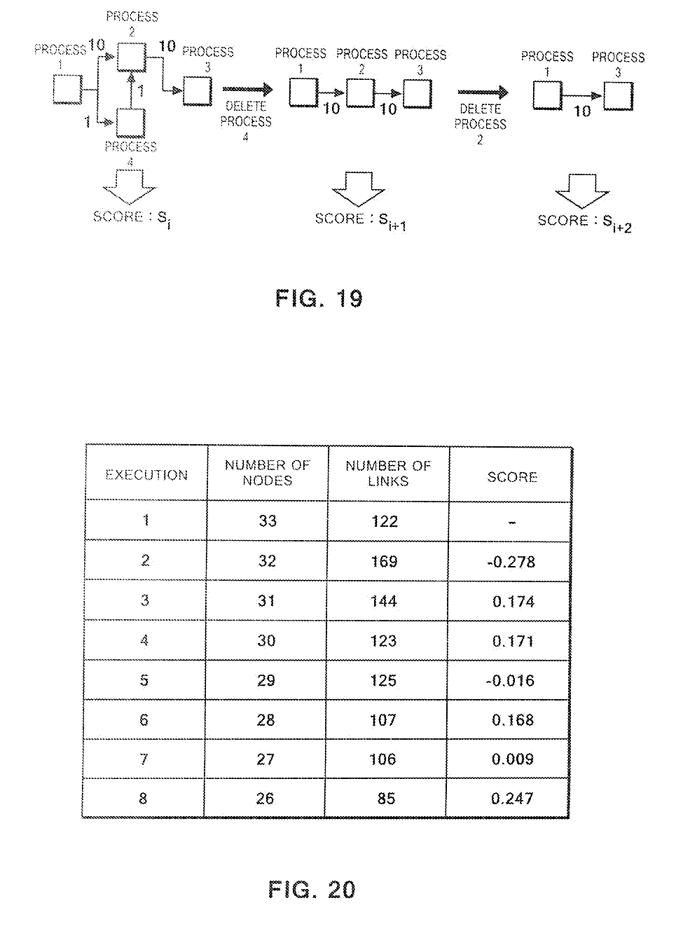

FIG. 19 is an example showing how the graph becomes simplified as the execution is repeated in the flowchart in FIG. 18. The score becomes different accordingly.

FIG. 20 shows, with numerical values, how the number of nodes, the number of links, and a score are changed by each execution. A higher score value indicates a more desirable level of graph simplification. Thus, the score value offers a measure for the user to determine the transition to the log pattern refinement step at the next stage.

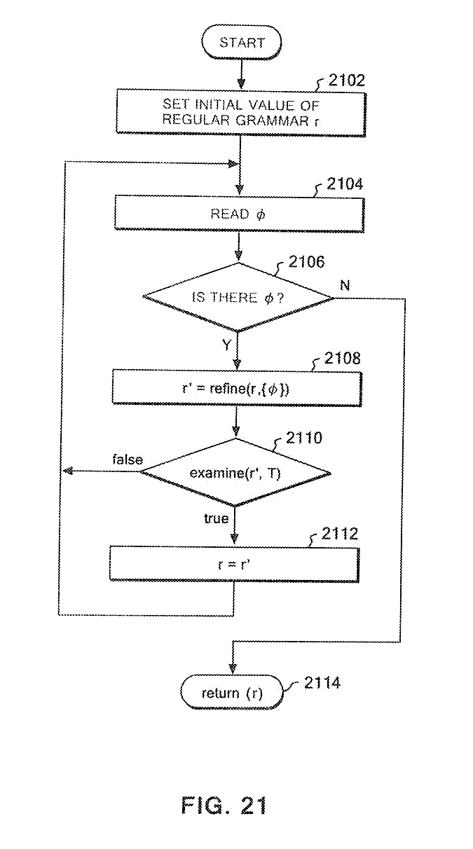

Next, the log pattern refinement step will be described by referring to FIG. 21 and the subsequent diagrams. As premises thereof, a set of events, a regular grammar, and constraints will be described first.

First of all, by taking the work logs in FIG. 3 as an example, an event refers to the content of processing. Then, a set of events Σ is as follows, for example:

{“start-claim-processing”, “complete-preprocessing”, “start-checking”, “complete-checking”, “start-machine-based-claim-examination”}

Next, a regular grammar r is as follows:

r::=e|x|r·r|r*|r∩r′|r∪r′|r^{c}

Here, e denotes the element of Σ; x, a variable; r·r, a concatenation of regular grammars; r*, zero or more repetitions of r; r∩r′ the intersection of 2 regular grammars r and r′, i.e., the set of words that belong both to r and r′; r∪r′, the union of 2 regular grammars, r and r′, i.e., the set of words that belong to either r or r′; and r^{c}, the complement of r, i.e., the set of words that do not belong to r.

For example, a regular grammar of {“start-claim-processing”}.*{“start-machine-based-claim-examination”} represents traces where {“start-machine-based-claim-examination”} will necessarily occur sometime after {“start-claim-processing”}.

Next, a constraint φ will be described. The constraint φ determines a condition which the regular grammar should satisfy.

The constraint φ is defined as follows:

φ₀::=x=r|φ₀ [symbol] φ₀

φ::=φ₀|φ₀ [symbol] φ

Here, φ₀, a basic constraint, is defined to be either ‘x=r’ (valuation of a variable x) or the conjunction of 2 basic constraints. In the second line, φ is defined to be either a basic constraint, φ₀, or an implication, φ₀ [symbol] φ.

For example, a constraint may be described as:

x=y·{“start-machine-based-claim-examination”}.* [symbol] y=.*{“complete-preprocessing”}.*

This constraint represents a condition that if {“start-machine-based-claim-examination”} is present, {“complete-preprocessing”} must be present before it.

A constraint other than the above is given as:

x=y·{“start-machine-based-claim-examination”} [symbol] y=[̂{“complete-checking”}]+

This constraint represents a condition that {“complete-checking”} is not included if the assessment ends in {“start-machine-based-claim-examination”}.

Still another example of the constraint is given as:

x=y·z [symbol] =(y=.*“inquire-code”).*= [symbol] z=.*{“inquire-code”}.*)

With the above constraints taken into consideration, this constraint represents a condition that if the assessment ends by issuing of a document and checking, and also code inquiry is made during the issuing of the document, the code inquiry is made also during the checking.

These constraints are described in advance by the user and stored in the main memory 106 or the hard disk drive 108 in such a manner that they can be called by the log pattern refinement module 216, as the constraints 226 in FIG. 2 show.

The constraints are created by finding a certain rule through looking at and analyzing past operation logs of the same type.

Next, processing by the log pattern refinement module 216 will be described by referring to a flowchart in FIG. 21. The above-described constraints as well as the log 418, which has been simplified as a result of the processing by the log processing module 204, serve as inputs in the processing in the flowchart in FIG. 21.

The simplified log 418 is formed of multiple log traces. The log traces here form flows starting at one process and ending at another process. A set of such log traces T is formed of the following six elements:

T={T₁,T₂,T₃,T₄,T₅,T₆}

In addition, the contents of these elements are as follows:

T₁={“start-claim-processing”}{“complete-preprocessing”}{“start-checking”}{“start-machine-ba sed-claim-examination”}{“register-completion”}

T₂={“start-claim-processing”}{“start-checking”}{“start-machine-based-claim-examination”}{“c omplete-checking”}

T₃={“inquire-code”}{“complete-preprocessing”}{“start-machine-based-claim-examination”}

T₄={“start-checking”}{“complete-checking”}{“start-machine-based-claim-examination”}

T₅={“inquire-code”}{“complete-preprocessing”}{“inquire-code”}{“start-machine-based-claim-examination”}

T₆={“start-checking”}{“inquire-code”}{“start-machine-based-claim-examination”}

In step 2102 in FIG. 21, the log pattern refinement module 216 sets the initial value for the regular grammar r. r=.* may be provided in advance as a given regular grammar, or the user may provide an appropriate value. r=.* is set in this example.

In step 2104, the log pattern refinement module 216 reads one constraint φ out of the constraints 226 prepared in advance by the user.

In step 2106, whether the constraint φ has been successfully read is determined, and if so, the log pattern refinement module 216 calls the refinement submodule 218 and in step 2108, refines the regular grammar r on the basis of the constraint φ.

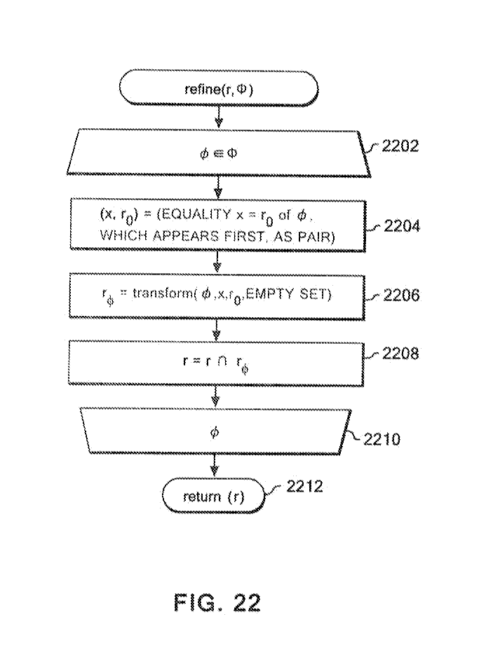

To be specific, a function refine( ) is called and r′=refine(r,{φ}) is executed. Processing for the function refine( ) being the refinement submodule 218 will be described later by referring to a flowchart in FIG. 22.

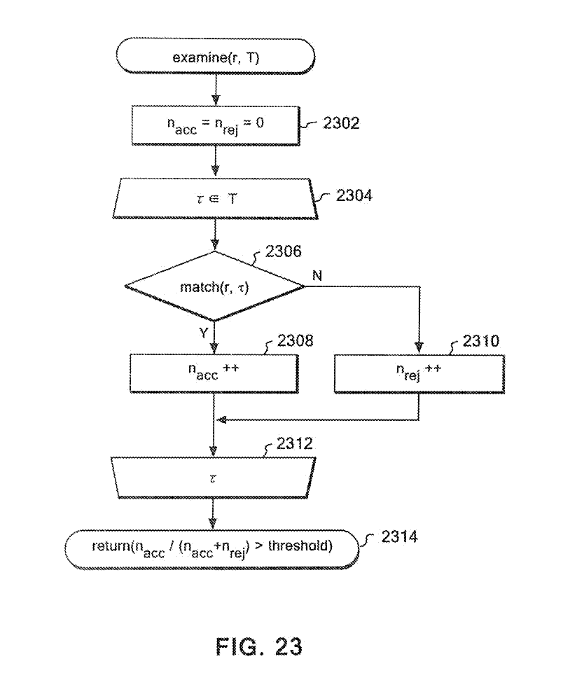

r′ is obtained as a result of the processing in step 2108. Then, in step 2110, the log pattern refinement module 216 calls the examination submodule 220 to examine the regular grammar r′ on the basis of the trace set T. To be specific, with r′ and T as arguments, a function examine(r′,T) is called. Processing for the function examine( ) being the examination submodule 220 will be described later by referring to a flowchart in FIG. 23.

In step 2110, if examine(r′,T) returns true, r is substituted with r′. On the other hand, if examine(r′,T) returns false in step 2110, r is not substituted.

The processing returns to step 2104. If the determination in step 2106 is such that there is not any constraint φ left, the log pattern refinement module 216 returns r in step 2114. This regular grammar r is transferred to the finite state transition system generation module 228.

Next, the processing for refine(r,Φ) executed by the refinement submodule 218 will be described by referring to the flowchart in FIG. 22. refine(r, Φ) refines the regular grammar r by using a set of constraints Φ. A series of steps from step 2202 to step 2210 in FIG. 22 is iterated sequentially for φ(φεΦ). If, however, called in step 2108 in FIG. 21, the function is called only once in the series of steps from step 2202 to step 2210 because Φ={φ}.

In step 2204, the refinement submodule 218 extracts an equality x=r₀ for φ, which appears first, as a pair (x,r₀).

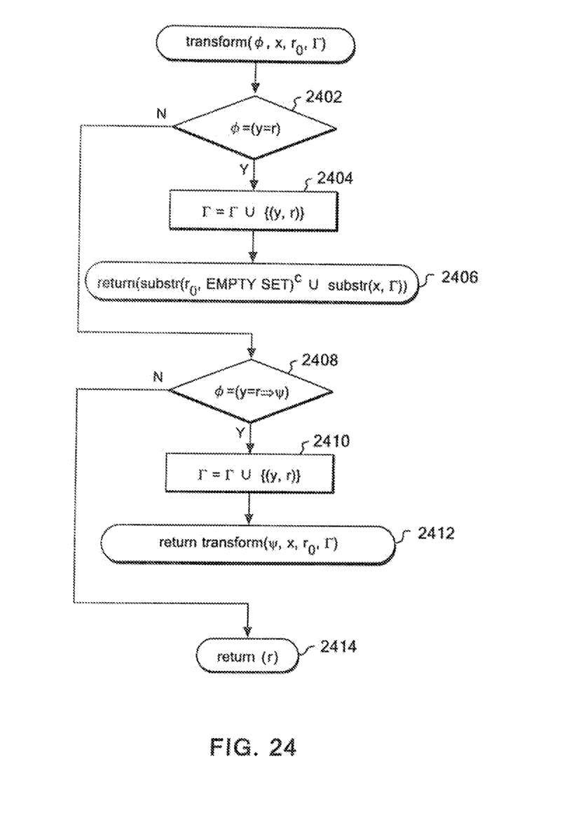

In step 2206, the refinement submodule 218 calls transform(φ,x,r₀,empty set) and assigns the return value thereof to r_{φ}. transform( ) is executed by the transformation submodule 224. The processing therefore will be described later in detail by referring to a flowchart in FIG. 24.

In step 2208, with r=r∩r_{φ}, the refinement submodule 218 narrows the regular grammar r.

After a predetermined number of iterations, the refinement submodule 218 leaves step 2210, and returns r in step 2212.

Next, the processing for examine(r,T) executed by the examination submodule 220 will be described by referring to the flowchart in FIG. 23. examine(r,T) evaluates the grammar obtained by the refinement. If the refinement is determined as being appropriate with T taken into consideration, true is returned. If not, false is returned. In step 2302, the examination submodule 220 sets both variables n_{acc} and nᵣₑᵢ to zero.

A series of steps from step 2304 to step 2312 is iterated for each element of T (TεT).

In step 2306, it is determined whether match(r,T), i.e., whether r accepts the log trace element T.

If it is determined in step 2306 that r accepts T, n_{acc} is incremented by 1. If not, nᵣₑⱼ is incremented by 1.

Then, in step 2314, a logical value of n_{acc}/(n_{acc}+nᵣₑⱼ)>threshold is returned. That is, if n_{acc}/(n_{acc}+nᵣₑⱼ)>threshold, the ratio of the accepted traces is regarded as being larger than the threshold, and examine(r,T) returns true. If not, examine(r,T) returns false.

Next, the processing for transform(φ,x,r₀,Γ) executed by the transformation submodule 224 will be described by referring to the flowchart in FIG. 24. transform( ) functions to transform the constraint φ into an equivalent regular grammar r_{φ}. Of the arguments in transform(φ,x,r₀,Γ), x denotes a grammar that is to be used for refinement; r₀, the initial value thereof; and Γ, a variable/regular-grammar correspondence table.

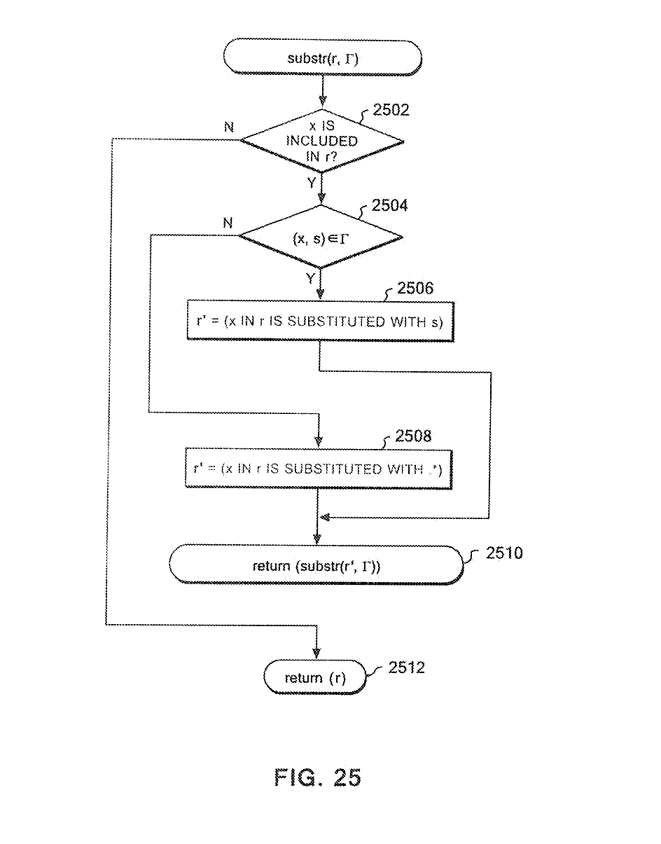

In step 2402, the transformation submodule 224 determines whether φ=(y=r). If so, Γ=Γ∪{(y,r)} and the correspondence table is added to Γ in step 2404. Then, in step 2406, the transformation submodule 224 returns substr(r₀,empty set)^{c}∩substr(x,Γ). Note that processing for substr( ) will be described later in detail by referring to a flowchart in FIG. 25.

On the other hand, if the transformation submodule 224 does not determine in step 2402 that φ=(y=r), the processing proceeds to step 2408, where whether φ=(y=r [symbol] ψ) is determined. If so, the correspondence table is added to Γ in step 2410 in accordance with Γ=Γ∪{(y,r)}. Then, in step 2412, the transformation submodule 224 recursively calls transform(φ,x,r₀,Γ) and returns a result thereof.

If determining in step 2408 that φ=(y=r= [symbol] ψ) is not true, the transformation submodule 224 returns r in step 2414.

Next, the processing for the function substr(r,Γ) executed by the substitution submodule 222 will be described by referring to the flowchart in FIG. 25.

In step 2502, the substitution submodule 222 determines whether x is included in r. If so, the substitution submodule 222 determines in step 2504 whether (x,s)εΓ, i.e., whether a pair (x,s) is included in Γ. If so, a regular grammar, which is obtained by substituting x in r with s, is assigned to r′ in step 2506. If not, a regular grammar, which is obtained by substituting x in r with .*, is assigned to r′ in step 2508. In either case, substr(r′,Γ) is recursively called, and the return value thereof is returned.

If determining in step 2502 that x is not included in r, the substitution submodule 222 simply returns r in step 2512.

For a more thorough understanding of the processing by the above function, the aforementioned constraints are used again.

Now, for the initial value of grammar r=.*, refine(r,{φ}) is executed with φ as the constraint. Then, the following are obtained:

x=y·{“start-machine-based-claim-examination”}.* [symbol] y=.*{“complete-preprocessing”}.* (1)

This means r_{φ}=(. {“start-machine-based-claim-examination”}.*}^{c}∪(.*{“complete-preprocessing”}.*{“start-machine-based-claim-examination”}.*).

x=y·{“start-machine-based-claim-examination”} [symbol] y=[̂{“complete-checking”}]+ (2)

This means r_{φ}=(.*{“start-machine-based-claim-examination”}.*}^{c}∪(.*[̂{“complete-checking”}]+{“start-machine-based-claim-examination”}).

x=y·z [symbol] (y=.*{“inquire-code”}.* [symbol] z=.*{“inquire-code”}.*) (3)

This means r_{φ}=(.*{“inquire-code”}.*}^{c}∪(.*{“inquire-code”}.*{“inquire code”}.*).

Here, it should be noted that the variables x and y are eliminated and thus r_{q}, contains no variable.

Meanwhile, the aforementioned constraints are again cited as follows.

T={T₁,T₂,T₃,T₄,T₅,T₆}

T₁={“start-claim-processing”}{“complete-preprocessing”}{“start-checking”}{“start-machine-ba sed-claim-examination”}{register completion}

T₂={“start-claim-processing”}{“start-checking”}{“start-machine-based-claim-examination”}{“c omplete-checking”}

T₃={“inquire-code”}{“complete-preprocessing”}{“start-machine-based-claim-examination”}

T₄={“start-checking”}{“complete-checking”}{“start-machine-based-claim-examination”}

T₅={“inquire-code”}{“complete-preprocessing”}{“inquire-code”}{“start-machine-based-claim-examination”}

T₆={“start-checking”}{“inquire-code”}{“start-machine-based-claim-examination”}

Then, the following can be found:

r_{φ}, in (1) accepts T1,T3, and T5 and rejects T2, T4, and T6.
r_{φ}, in (2) accepts T1,T2, T3, T5, and T6 and rejects T4.
r_{φ}, in (3) accepts T1,T2,T4, and T5 and rejects T3 and T6.

The role of the log pattern refinement module 216 is to apply such constraints, examine the acceptance rate for the log traces T, and refine the regular grammar in a stepped fashion. In this event, the transformation submodule 224 and the substitution submodule 222 are called by the refinement submodule 218 for the refinement processing.

The regular grammar finally obtained is transferred to the finite state transition system generation module 228.

In the following, the terms for describing the processing by the finite state transition system generation module 228 are defined again.

Specifically, Σ=set of alphabets, and Σ*=set of words obtained by joining an arbitrary number of alphabets.

The regular expression r is defined as r ::=ε|a|r∪r|r∩r|r^{c}|r·r|r*, where a is an arbitrary element of the alphabet set Σ, and ε is a special symbol not belonging to Σ. Note that the regular expression r may also be called the regular grammar.

Moreover, a nondeterministic finite state transition machine including ε-transition (ε-NFA)M is defined as follows:

Q=set of states={q₀, q₁, q₂ . . . }
Σ=set of alphabets
ε=special transition not belonging to Σ
Δ=set of state transitions (Δ⊂Q×(Σ∪{ε})×Q)
q₀=initial state
F=set of final states
L(M)=set of words accepted by ε-NFA M

Now, assume that M₁=(Q₁,Σ∪{ε},Δ₁,q₁,F₁) and M₂=(Q₂,Σ∪{ε},Δ₂,q₂,F₂). With M₁ and M₂ as above, functions to be used are defined as follows:

disj(M₁,M₂)=ε-NFA accepting L(M₁)∪L(M₂), or a set of words defining ε-NFA such that the ε-NFA is branched to M₁ or M₂ by ε-transition;
conj(M₁,M₂)=ε-NFA accepting L(M₁)∪L(M₂), defined such that (q₁,q₂),a,(q′₁,q′₂) would be a transition of conj(M₁,M₂) when (q₁,a,q′₁)εΔ₁ and (q₂,a,q′₂)εΔ₂ for the direct product of transition sets Q₁×Q₂;

neg(M₁)=ε-NFA accepting Σ*\L(M₁), or a ε-NFA in which the accepting and non-accepting (rejecting) states are reversed;

concat(M₁,M₂)=ε-NFA accepting {w₁·w₂|w₁εL(M₁),w₂εL(M₂)}, or a ε-NFA in which M₁ and M₂ are joined by adding an ε-transition from F₁ to q₂; and
rep(M₁)=ε-NFA accepting {w*|wεL(M₁)}, or a ε-NFA in which an ε-transition from F₁ to q₁ and an ε-transition that ends without passing M₁ are added.

Pseudo code which the finite state transition system generation module 228 uses for processing a function RE_to_eNFA(r) that transforms the regular expression into an equivalent ε-NFA(nondeterministic finite automaton) by using these functions are described as follows. As can be seen, this is recursive processing:

procedure RE_to_eNFA(r)
begin
case r in
ε:return(M = ({q₀},{ },{ },q₀,{q₀}))
a:return(M = ({q₀,q₁},{a},{(q₀,a,q₁)},q₀,{q₁}))
r₁∪r₂:return(disj(RE_to_eNFA(r₁),RE_to_eNFA(r₂)))
r₁∩r₂:return(conj(RE_to_eNFA(r₁),RE_to_eNFA(r₂)))
r^{c}:return(neg(RE_to_eNFA(r)))
r1•r2:return(concat(RE_to_eNFA(r₁),RE_to_eNFA(r₂)))
r*:return(rep(RE_to_eNFA(r)))
endcase
end

Next, another function of the finite state transition system generation module 228 is to transform the ε-NFA (nondeterministic finite automaton) acquired by RE_to_eNFA(r) into a DFA (deterministic finite automaton).

Here, definitions are given such that when the nondeterministic finite state transition machine (ε-NFA)M including ε-transition=(Q,Σ∪{ε},Δ,q₀,F):

Q=set of states={q₀, q₁, q₂ . . . }
Σ=set of alphabets

ε=special transition not belonging to Σ

Δ=set of state transitions (Δ⊂Q×(Σ∪{ε})×Q)
q₀=initial state

F=set of final states

Meanwhile, a deterministic finite state transition machine (DFA)M=(Q,Σ,Δ,q₀,F).

Here, functions to be used are defined as follows:

ε-closure(q)=set of states that are reachable from q while transitions other than ε-transition are removed. That is, qεε-closure(q), (q,ε,q′)εΔ [symbol] ε-closure(q′)⊂ε-closure(q).
Set of states that are reachable from t(q,a) in an ε-transition and an a-transition (each of which is performed arbitrary times)=∪{ε-closure(q″)|q′εε-closure(q),(q′,a,q″)εΔ}.

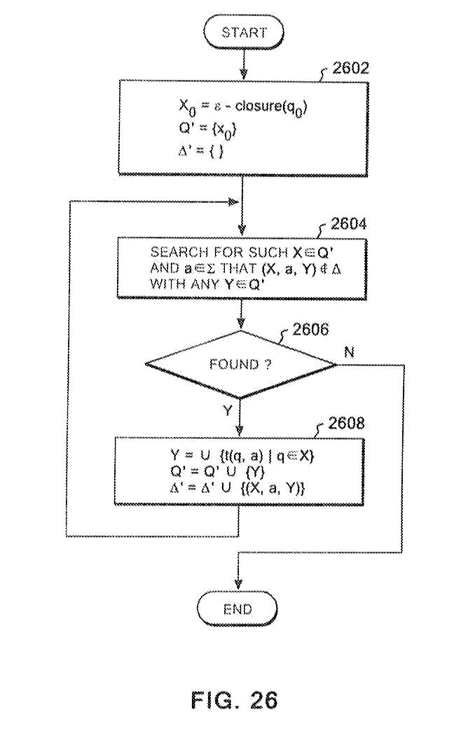

Next, the processing to transform a ε-NFA into a DFA will be described by referring to a flowchart in FIG. 26. In this processing, an input is ε-NFA M=(Q,Σ∪{ε},Δ,q,F) whereas an output is DFA M′=(Q,Σ,Δ′,X,F), where F′={XεQ′|X∩F≠{ }}.

In step 2602 in FIG. 26, the finite state transition system generation module 228 assigns such that X₀=ε-closure(q₀), Q′={X₀}, and Δ′={ }.

In step 2604, the finite state transition system generation module 228 searches for a transition destination of X through a, which has not been checked. Specifically, the finite state transition system generation module 228 searches for such XεQ′ and aεΣ that (X,a,Y) is not an element of Δ′ with any YεQ′.

In step 2606, it is determined whether the above are found. If not, the processing ends.

If it is determined in step 2606 that the above are found, Y=∪{t(q,a)|qεX}, Q′=Q′∪{Y}, and Δ′=Δ′u{(X,a,Y)} are set in step 2608, and the processing returns to step 2604.

The function of the finite state transition system generation module 228 is to generate a DFA from the regular expression r in the above manner. In the following, a description will be given of the function of the workflow transformation module 230 that generates a workflow from the generated DFA.

Due to its algorithm, the workflow transformation module 228 does not directly generate a workflow from the DFA, and instead generates a pseudo-workflow first.

In the following, variables and functions are defined for the purpose of describing the algorithm:

deterministic finite state machine DFA M=(Q,Σ,Δ,q₀,F)
Q=set of states={q₀,q₁,q₂, . . . }
Σ=set of alphabets
Δ=set of state transitions (Δ⊂Q×Σ×Q)
q₀=initial state
F=final state
pseudo-workflow pWF=(N,E), a directed graph taking a transition a(εΣ) of DFA as a node and being used as a stage before generating a workflow
task node n=a(i,j), N=set of task nodes
a=element of Σ
i=number given to the entrance of task node n
j=number given to the exit of task node n
e=edge, E=set of edges

Functions to be used are defined as follows:

count(a)=the number of task nodes in N that are in the form of a(______,______)
init(e)=initial point of edge e (initial node)
term(e)=terminal point of edge e (terminal node)

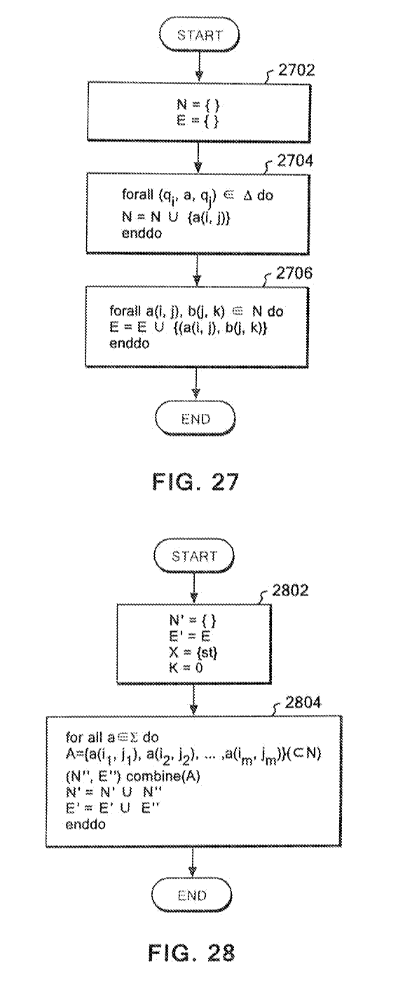

Next, processing to generate a pseudo-workflow from the DFA will be described by referring to a flowchart in FIG. 27. In this processing, an input is DFA M=(S,Σ,Δ,s₀,F) whereas an output is pseudo-workflow pWF=(N,E).

In step 2702 in FIG. 27, the workflow transformation module 228 sets an empty set to both N and E.

In step 2704, the workflow transformation module 228 processes N=N∪{a(i,j)} for all the elements (qᵢ,a,qⱼ) of to thereby generate a node set N.

In step 2706, the workflow transformation module 228 processes E=E∪{a(i,j),b(j,k)} for all the elements a(i,j) and b(j,k) of N to thereby generate an edge set E.

Next, processing to generate a workflow from the pseudo-workflow will be described.

workflow WF=(N,E,X)

Here, the workflow is determined as a flowchart-like structure. The workflow is associated with a set of variables X, and may have update nodes of XεX (x:= . . . ) and branch nodes dependent on the values of x.

The node n is any one of the following:

update(x,v): updating the value of the variable x to v.
label(a): providing a as a label (a is an alphabet of the DFA). Note that in the workflow, there are at maximum two nodes that have the label of a.
branch.

The edge e connects nodes n and n′. The flow of the processing therefore is shown below.

In particular, an edge exiting from a branch node is associated with a condition “x=v” (that edge is selected when the value of x is v).

combine(A) creates WF nodes and edges corresponding to nodes gathered by A={a(i₁,j₁),a(i₂,j₂), . . . , a(iₘ,jₘ)} among nodes in the pseudo-workflow.

Next, processing to generate a workflow from the pseudo-workflow will be described by referring to a flowchart in FIG. 28. In this processing, an input is the pseudo-workflow(N,E), while an output is a workflow(N′,E′,{st}).

In step 2802 in FIG. 28, the workflow transformation module 228 performs initialization such that N′={ }, E′=E, X={st}, and k=0.

In step 2804, the workflow transformation module 228 processes the following for all a in Σ.

A={a(i₁,j₁),a(i₂,j₂), . . . ,a(iₘ,jₘ)}

(N″,E″)=combine(A)

N′=N′∪N″

E′=E′∪E″

Then, the workflow transformation module 228 ends the processing. After data of the workflow(N′,E′,{st}) is acquired in the above manner, appropriate drawing processing may be performed using the data to display the workflow on the display 114.

As an example, a regular expression r=([̂<“start-machine-based-claim-examination”>]*)^{c}∪([̂<“start-machine-based-claim-exam ination”>]*<“complete-preprocessing”>[̂<“start-machine-based-claim-examination”>]*.*<“start-machine-based-claim-examination”>.*) is considered.

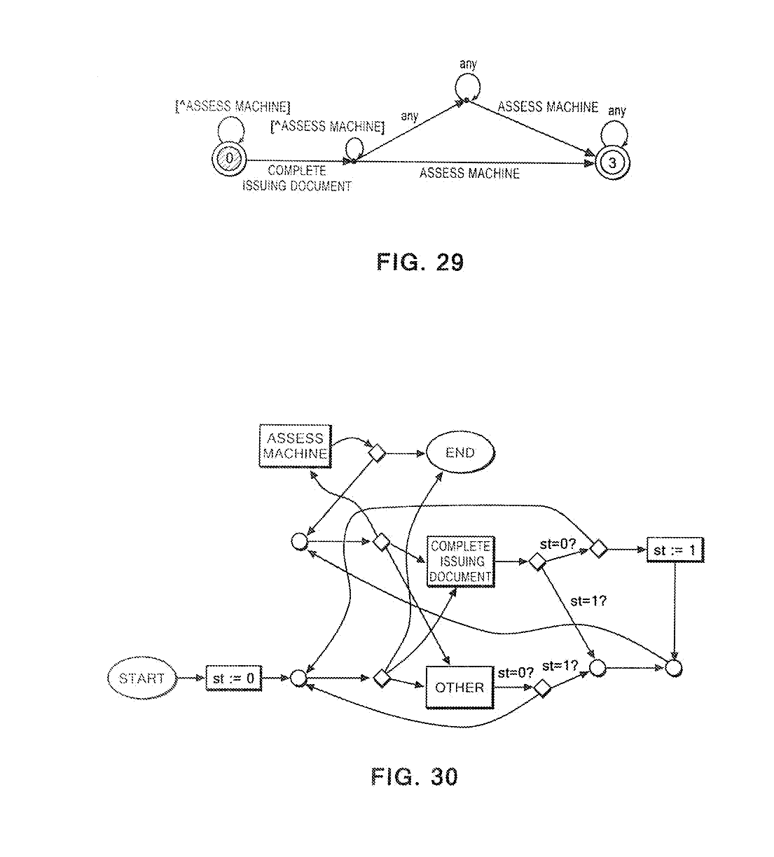

FIG. 29 is a diagram showing a state transition system generated by the finite state transition system generation module 228.

FIG. 30 is a final workflow generated by the workflow transformation module 230 by using the state transition system.

The present invention has been hereinabove described based on a particular embodiment. However, the present invention is not limited to a particular operation system or a platform, and can be carried out on any computer system.

Moreover, the operation log that serves as the base of the analysis is not limited to a particular operation log such as an insurance operation log. The present invention is applicable to any type of log as long as the log has operation contents, work contents, or IDs thereof arranged in a time-series manner and is stored in a computer-readable manner.

According to the present invention, the processing is performed in which a simplified log is first prepared by removing a node recognized as a noise from a log of a business process, and subsequently a regular grammar is refined based on constraints so that the regular grammar may be compatible with the simplified log. As a result, the log is fitted into the regular grammar. Accordingly, an advantageous effect can be achieved which allows the generation of a suitable workflow even from a log of an unstructured business process.

What is claimed is:

1. A method of creating a workflow comprising:
creating a work graph on the basis of a work log, wherein said work log is recorded through a series of operations performed by an operator;
identifying and removing a redundant graph in said created work graph;
simplifying said work log by deleting an entry corresponding to said removed redundant graph from said work log;
reading a set of constraints to be satisfied by log entries, wherein each of the said constraints defines an expression including a regular expression having a variable;
changing a prepared regular expression by applying one of the said constraints to an initial value of said prepared regular expression;
determining whether said changed regular expression is appropriate for said simplified log; and
creating a graph of a workflow by creating a finite state transition system on the basis of said changed regular expression in response to a determination that said changed regular expression is appropriate.

2. The method according to claim 1, wherein determining whether said changed regular expression is appropriate further comprises determining said changed regular expression as being appropriate when a plurality of log traces included in said simplified log have a higher ratio of log traces accepted by said changed regular expression than a predetermined threshold.

3. The method according to claim 1, wherein said step of changing said regular expression further comprises changing said regular expression so that variables in said constraints to be applied are erased.

4. The method according to claim 1, wherein the initial value of said prepared regular expression is .*.

5. An article of manufacture tangibly embodying computer readable instructions which, when executed, cause a computer to carry out the steps of a method for creating a workflow, the method comprising:
a computer readable storage medium having computer readable program code embodied therewith, the computer readable program code comprising:
computer readable program code configured to perform the steps of:
creating a work graph on the basis of a work log, wherein said work log is recorded through a series of operations performed by an operator;
identifying and removing a redundant graph in said created work graph;
simplifying said work log by deleting an entry corresponding to said removed redundant graph from said work log;
reading a set of constraints to be satisfied by log entries, wherein each of the said constraints defines an expression including a regular expression having a variable;
changing a prepared regular expression by applying one of the said constraints to an initial value of said prepared regular expression;
determining whether said changed regular expression is appropriate for said simplified log; and
creating a graph of a workflow by creating a finite state transition system on the basis of said changed regular expression in response to a determination that said changed regular expression is appropriate.

6. The article of manufacture according to claim 5, wherein determining whether the changed regular expression is appropriate further comprises determining said changed regular expression as being appropriate when a plurality of log traces included in said simplified log have a higher ratio of log traces accepted by said changed regular expression than a predetermined threshold.

7. The article of manufacture according to claim 5, wherein said step of changing said regular expression further comprises changing said regular expression so that variables in said constraints to be applied are erased.

8. The program according to claim 5, wherein the initial value of said prepared regular expression is .*.

9. A system for creating a workflow comprising:
means for creating a work graph on the basis of a work log, wherein said work log is recorded through a series of operations performed by an operator;
means for identifying and removing a redundant graph in said created work graph;
means for simplifying said work log by deleting an entry corresponding to said removed redundant graph from said work log;
means for reading a set of constraints to be satisfied by log entries, wherein each of the said constraints defines an expression including a regular expression having a variable;
means for changing a prepared regular expression by applying one of the said constraints to an initial value of said prepared regular expression;
means for determining whether said changed regular expression is appropriate for said simplified log; and
means for creating a graph of a workflow by creating a finite state transition system on the basis of said changed regular expression in response to a determination that said changed regular expression is appropriate.

10. The system according to claim 9, wherein means for determining whether said changed regular expression is appropriate further comprises means for determining said changed regular expression as being appropriate when a plurality of log traces included in said simplified log have a higher ratio of log traces accepted by said changed regular expression than a predetermined threshold.

11. The system according to claim 9, wherein means for changing said regular expression further comprises means for changing said regular expression so that variables in said constraints to be applied are erased.

12. The system according to claim 9, wherein the initial value of the prepared regular expression is .*.
